(19) United States
(12) Patent Application Publication
(10) Pub. No.: US 2013/0106097 A1
(43) Pub. Date: May 2, 2013

(54) Structure for fastening outlet module of water purifier

(71) Applicants: Kil Jae Kim, Kwangju-gun (KR); Kil Ho Kim, Kwangju-gun (KR)

(72) Inventors: Kil Jae Kim, Kwangju-gun (KR); Kil Ho Kim, Kwangju-gun (KR)

(21) Appl. No.: 13/317,698

(22) Filed: Oct. 26, 2011

(51) Int. Cl. F16L 21/08; F16L 55/00

(52) U.S. Cl. 285/119; 285/404

(57) ABSTRACT

A structure for fastening an outlet module in a water purifier in order to supply hot and/or cold water to the outside. In the water purifier, a supply module has a flow rate sensor and a filter and is configured to supply hot and/or cold water through a supply pipe disposed in a side portion thereof. An outlet module is connected to the supply pipe via a connector pipe and configured to open and close an outlet port of hot and/or cold water via a lever member disposed in a body thereof. The structure includes a fitting member having a plurality of recesses and a plurality of protrusions formed sequentially on an outer circumference thereof, a coupling-hole formed in a periphery of the connector pipe, and a fastening member fitted into the coupling-hole to connect the connector pipe and the supply pipe to each other.

### BACKGROUND OF THE INVENTION

1. Field of the Invention

The present invention relates to an outlet module that is mounted on a cold or hot water outlet line of a water purifier in order to supply hot and/or cold water to the outside and, more particularly, to a structure for fastening an outlet module in a water purifier, the outlet module being fastened with one touch in order to minimize the burden and cost of work associated with the maintenance of the water purifier.

2. Description of Related Art

In general, a water purifier is a type of sanitation product that purifies raw water, such as tap water, and then discharges hot and/or cold water that is harmless to the human body. The water purifier can be divided into a faucet-attached type, which is directly attached to a faucet to purify water, or a desk type, which supplies water contained in a water tank via natural gravity.

The water purifier is equipped with a variety of convenient parts so that a user can drink hot and/or cold water through a simple manual operation. In particular, a lever type is generally used, in which hot and/or cold water is discharged with one touch when an opening/closing lever, disposed on the front portion of the purifier, is raised like a hinge.

In an example, as shown in FIG. 1, a water purifier 100 includes a body 120 and an outlet valve 140 mounted on the body 120. The outlet valve 140 has an opening/closing lever 142 thereon to open and close an outlet pipe for hot and/or cold water. A flow rate sensor 160 is disposed at the entrance of the outlet valve 140 to detect the rate of flow of exiting water.

Consequently, when the opening/closing lever 142 of the water purifier 100 is turned, the outlet valve 140 is operated to open the outlet pipe for hot and/or cold water so that hot and/or cold water contained in the body 120 is discharged to the outside via an outlet 144 of the outlet valve 140.

The outlet valve 140 is coupled to the side portion of the body 120 via screw engagement or interference fitting such that it protrudes outwards from the body 120. The outlet valve 140 must be frequently replaced or repaired, since it may be damaged or caused to malfunction due to frequent friction with users of the water purifier 100 or surrounding devices.

In the water purifier 100, however, pipes used to connect components, including the outlet valve 140, are complicated. This makes it difficult to provide space for disassembling and assembling the outlet valve 140. When it is desired to replace the outlet valve 140, all parts of the water purifier must be disassembled. This disadvantageously prolongs the replacement operation.

Accordingly, the operation of disassembling and assembling the outlet valve 140 is complicated, thereby increasing the cost and load of the operation.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a structure for fastening an outlet module in a water purifier such that the outlet module is fastened to a side wall of the water purifier with one touch.

In an aspect of the present invention, provided is a structure for fastening an outlet module in a water purifier. The water purifier includes a supply module having a flow rate sensor and a filter, the supply module configured to supply hot and/or cold water through a supply pipe disposed in a side portion thereof, and an outlet module connected to the supply pipe via a connector pipe, the outlet module configured to open and close an outlet port for hot and/or cold water via a lever member disposed in a body thereof. The structure includes a fitting member having a plurality of recesses and a plurality of protrusions formed sequentially on the outer circumference thereof, a coupling-hole formed in the periphery of the connector pipe, and a fastening member fitted into the coupling-hole to connect the connector pipe and the supply pipe to each other.

According to embodiments of the present invention, the supply module and the outlet module of the water purifier are connected together with one touch via the fastening member. There are effects in that the operation of disassembling and assembling the outlet module is made more convenient and that operations associated with the maintenance of the water purifier are made more convenient.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is an assembly view showing an outlet module of a water purifier according to a related art;

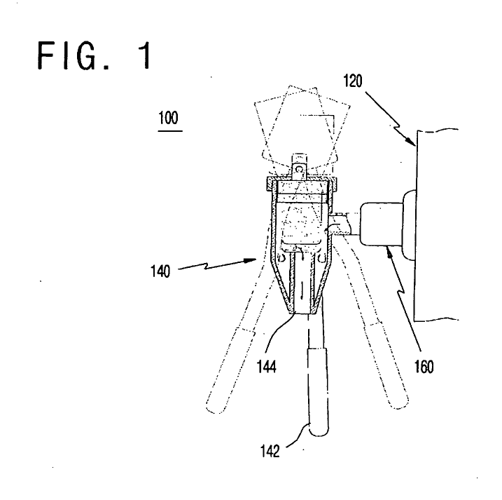

FIG. 2 is a perspective assembly view showing a structure for fastening an outlet module in a water purifier according to an exemplary embodiment of the present invention;

FIG. 3 is an exploded perspective view showing a structure for fastening an outlet module in a water purifier according to an exemplary embodiment of the present invention;

FIG. 4 is a front elevational assembly view showing a structure for fastening an outlet module in a water purifier according to an exemplary embodiment of the present invention; and

FIG. 5 is a top plan assembly view showing a structure for fastening an outlet module in a water purifier according to an exemplary embodiment of the present invention.

### DETAILED DESCRIPTION OF THE INVENTION

Reference will now be made in detail to various embodiments of the present invention, examples of which are illustrated in the accompanying drawings and described below. While the invention will be described in conjunction with exemplary embodiments thereof, it is to be understood that the present description is not intended to limit the invention to those exemplary embodiments. On the contrary, the invention is intended to cover not only the exemplary embodiments, but also various alternatives, modifications, equivalents and other embodiments that may be included within the spirit and scope of the invention as defined by the appended claims.

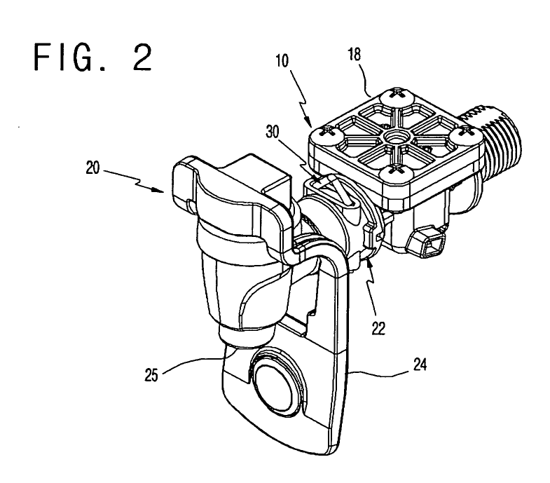

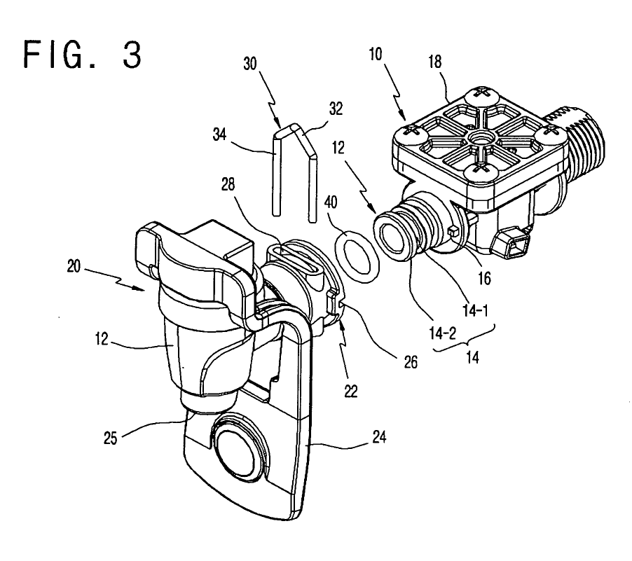

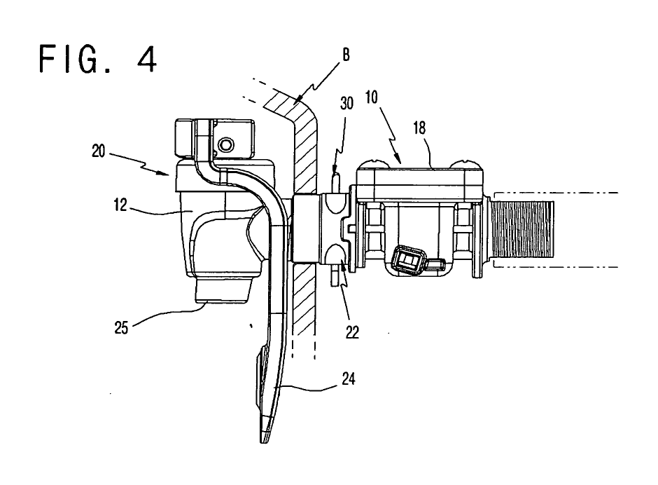

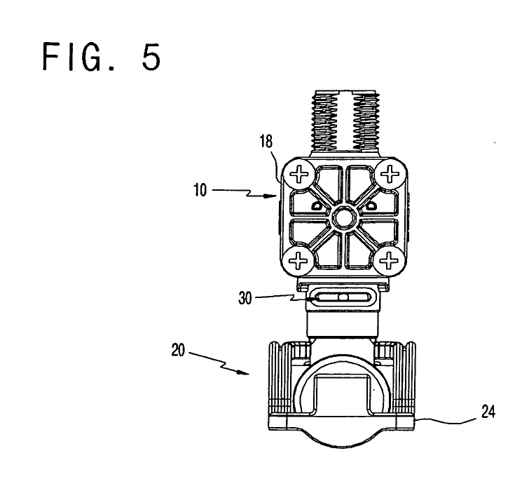

FIG. 2 and FIG. 3 are a perspective assembly view and an exploded perspective view showing a structure for fastening an outlet module in a water purifier according to an exemplary embodiment of the present invention, and FIG. 4 and FIG. 5 are a front elevational assembly view and a top plan assembly view showing a structure for fastening an outlet module in a water purifier according to an exemplary embodiment of the present invention.

Referring to FIG. 2 to FIG. 5, a supply module 10 and an outlet module 20 of a water purifier are shown. The supply module 10 has a flow rate sensor and filters, and serves to supply hot and/or cold water through a supply pipe 12 disposed in a side portion thereof. The outlet module 20 is connected to the supply pipe 12 via a connector pipe 22, and serves to open and close an outlet port 25 for hot and/or cold water via a lever member 24 disposed in the body thereof. The structure for fastening an outlet module in a water purifier also includes a fitting member 14 that has a plurality of recesses 14-1 and a plurality of protrusions 142 formed sequentially on the outer circumference thereof. A coupling-hole 28 is formed in the periphery of the connector pipe 22. A fastening member 30 is fitted into the coupling-hole 28 to connect the connector pipe 22 and the supply pipe 12 to each other.

First, in this embodiment, the supply module 10, which includes the flow rate sensor and the filters, and the outlet module 20, which includes the lever member 24 and the outlet valve, are coupled to each other. In particular, the supply module 10 indicates a body B of the water purifier, and the outlet module 20 indicates the outlet valve 12 of the water purifier.

Here, the flow rate sensor 18 and a variety of filters necessary for purifying water of the supply module 10, a variety of electromechanical components necessary for cooling and heating water, pipes necessary for feeding hot and/or cold water, and buttons necessary for discharging hot and/or cold water are known in the art, and thus descriptions thereof will be omitted.

In addition, the structures for operating the outlet valve of the outlet module 20, which selectively discharges hot and/or cold water; the lever member 24, which opens and closes a passage of the outlet valve; and the outlet port 25, which supplies hot and/or cold water to the user in response to the selection of the outlet valve are known in the art, and thus descriptions thereof will be omitted.

In the meantime, the supply module 10 is a body that forms part of the outer shell of the water purifier, and in which a variety of components, including the flow rate sensor 18, are contained. The supply module 10 also has, in a side portion thereof, the supply pipe 12, which is a hot and/or cold water feed pipe for guiding hot and/or cold water, which has passed through the flow rate sensor 18, to the outlet module 20.

In the process of constructing the supply module 10, the position of the flow rate sensor 18 can be changed to any position depending on the design of the water purifier. Even though the position of the flow rate sensor 18 is changed according to the design, the flow rate sensor 18 is of course embraced within the scope of the present invention, as long as it is disposed on the passage of the flow of hot and/or cold water.

In addition, the supply module 10 has an indicator window (not shown), which displays the time to replace a filter upon receiving a signal from the flow rate sensor 18, so that the user can readily recognize the time to replace the filter.

Furthermore, the fitting member 14 is provided on the outer circumference of the supply pipe 12, is fitted into the inner circumference of the connector pipe 22, and includes the recesses 14-1 and the protrusions 14-2, which are sequentially formed at predetermined intervals from each other.

In place of the protrusions 14-2 of the fitting member 14, an O-ring may be fitted on the outer circumference of the supply pipe 12.

In addition, a plurality of setting protrusions 16 is provided on the outer circumference of the supply pipe 12. The setting protrusions 16 serve to set the position at which the supply pipe 12 is coupled to the connector pipe 22.

Although this embodiment of the present invention has been described that only one supply pipe 12 is provided, a plurality of supply pipes 12 may of course be provided in order to supply various types of purified water, including hot water and cold water.

The outlet module 20 is an outlet valve, which is mounted on a side portion of the supply module 10 to selectively supply hot and/or cold water fed from the supply module 10. The outlet module 20 has the connector pipe 22 mounted on a side portion thereof, such that the connector pipe 22 is coupled with the supply pipe 12 in a mating fashion so that hot and/or cold water can pass through.

In addition, the lever member 24 is hingeably mounted on the upper surface of the outlet module 20, preferably on the upper portion of the outlet valve 12, as means for selectively opening and closing the outlet port 25 for hot and/or cold water.

Furthermore, the coupling-hole 28 having a predetermined size is formed in the periphery of the connector pipe 22, preferably in the upper portion of the connector pipe 22, and the fastening member 30, which will be described later, is fitted with one touch into the coupling-hole 28.

It is preferred that coupling-holes 28 be formed at opposite portions in the connector pipe 22 such that the fastening member 30 can be easily inserted into the coupling-holes 28.

In addition, a plurality of setting-holes 26, which mate with the setting protrusions 16, is formed in the front end of the connector pipe 22.

Here, although the positions of the components 14 and 16 formed on the outer circumference of the supply pipe 12 are exchanged with those of the components 26 and 28 formed on the outer circumference of the connector pipe 22, those components, 14 and 16, and 26 and 28, are of course embraced within the scope of the present invention.

In addition, the fastening member 30 maintains the connection between the connector pipe 22 and the supply pipe 12 in the state in which it is fitted into the coupling hole 28. The fastening member 30 includes a body 32, which is configured to butt against the upper portion of the coupling hole 28, and a pair of legs 34, which are formed on opposite ends of the body 32 and extend parallel to each other.

Here, the body 32 is folded or spread through at least one joint while butting against the upper portion of the coupling-hole 28.

Furthermore, the legs 34 are coupled to opposite ends of the body 32 via respective joints, pass through regions of the coupling-hole 28, and are fitted into a corresponding one of the recesses 14-1.

A description is given below of the operation of the fastening structure of the present invention.

First, when assembling the supply module 10 and the outlet module 20 together, the connector pipe 22 of the outlet module 20 is brought to butt against the supply pipe 12 of the supply module 10, and is then lightly pushed into the supply pipe 12.

In this state, the fitting member 14, which is formed on the outer circumference of the supply pipe 12, is in close contact with the inner circumference of the connector pipe 22, thereby maintaining a seal between the supply pipe 12 and the connector pipe 22.

Here, an O-ring 40 may be disposed in a contact region between the supply pipe 12 and the connector pipe 22 in order to enhance the seal therebetween.

Furthermore, since the setting protrusions 16 of the supply pipe 12 and the setting recesses 26 of the connector pipe 22 are set to face each other in the process of fastening the outlet module 20, the operation of coupling the connector pipe 22 can be performed with one touch.

Afterwards, when coupling the supply module 10 and the outlet module 20 to each other, the legs 34 of the fastening member 30 are fitted into the coupling-hole 28 of the outlet module 20 so that the legs 34 are fitted into a corresponding one of the recesses 14-1.

When the operation of fastening the fastening member 30 is completed, the operation of fixing the outlet module 20 is finished. This consequently makes it possible to fundamentally prevent separation and leakage even if external force is applied to the outlet module 20.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure for fastening an outlet module in a water purifier, which comprises a supply module having a flow rate sensor and a filter, the supply module configured to supply hot and/or cold water through a supply pipe disposed in a side portion thereof, and an outlet module connected to the supply pipe via a connector pipe, the outlet module configured to open and close an outlet port of hot and/or cold water via a lever member disposed in a body thereof, the structure comprising:
a fitting member having a plurality of recesses and a plurality of protrusions formed sequentially on an outer circumference thereof;
a coupling-hole formed in a periphery of the connector pipe; and
a fastening member fitted into the coupling-hole to connect the connector pipe and the supply pipe to each other.

2. The structure of claim 1, wherein the fastening member comprises:
a body butting against an upper portion of the coupling-hole; and
a pair of legs formed on opposite ends of the body, the legs being fitted into a corresponding one of the recesses.

3. The structure of claim 1, wherein the supply pipe has a setting protrusion on an outer circumference thereof, the setting protrusion setting a coupling position of the connector pipe.

4. The structure of claim 3, wherein the connector pipe has a setting recess in a front end thereof, the setting recess mating with the setting protrusion.

5. The structure of claim 1, wherein the connector pipe has a setting recess in a front end thereof, the setting recess mating with the setting protrusion.

6. The structure of claim 1, wherein the supply module has an indicator window that outputs a time to replace the filter in response to a signal from the flow rate sensor.
